(19) United States
(12) Patent Application Publication
(10) Pub. No.: US 2019/0248707 A1
(43) Pub. Date: Aug. 15, 2019

(54) HIGH PERFORMANCE CERAMICS FROM COLD SINTERED NANOSCALE POWDERS

(71) Applicant: ETH ZÜRICH, Zürich (CH)

(72) Inventors: Florian BOUVILLE, Baden (CH); Andre R. STUDART, Zurich (CH)

(73) Assignee: ETH ZÜRICH, Zürich (CH)

(21) Appl. No.: 16/314,872

(22) PCT Filed: Jul. 4, 2017
(86) PCT No.: PCT/EP2017/066684

§ 371 Date: Jan. 3, 2019

(30) Foreign Application Priority Data
Jul. 5, 2016 (EP) 16177961.6

(51) Int. Cl. C04B 35/057; C04B 35/626

(52) U.S. Cl. CPC C04B 35/057; C04B 35/645; C04B 35/62645; C04B 2235/77; C04B 2235/5445; C04B 2235/448; C04B 2235/442; C04B 2235/447; C04B 2235/445; C04B 2235/3244; C04B 2235/3236; C04B 2235/3217; C01P 2004/50; C04B 2235/60; C04B 2235/449; C04B 2235/3215; C04B 2235/3213; C04B 2235/3208; C04B 35/62635

(57) ABSTRACT

The invention relates to a process for making a ceramic body that comprises providing particles of a metal salt precursor material wetted by a liquid medium. The particles are characterized by a grain size of below 600 nm, and the precursor material has a solubility in the liquid medium of at least 10⁻⁵ mol/L. A pressure of ≥100 MPa is applied at a temperature of below 100° C., rendering a material of high theoretical density values previously unattainable at low temperatures. The invention further relates to a calcium carbonate ceramic material of the vaterite isomorph having a density of the material ≥1.76 g/cm3 and a Modulus of rupture ≥30 MPa, and to a calcium phosphate ceramic material consisting of the monetite isomorph with ≥2.5 g/cm3 density and a Modulus of rupture ≥18 MPa.

Pressure solution creep or cold sintering relies on the transport of matter from the contact between touching particles to the surrounding continuous phase and eventually to nearby non-contacting surfaces. Such transport locally decreases the distance between the particle centres, enabling global shrinkage and densification. The motion of ions during cold sintering is driven by the high stress concentration at the contact point (grain boundary) when the particle compact is subjected to an externally applied mechanical load. In response to such stress concentration, ions at the contact point dissolve from the solid particle into the interfacial water film, and eventually diffuse along the grain boundary before reaching the continuous liquid phase and precipitating on a non-stressed particle surface. This mechanism of ionic transport underlies the densification process of carbonate rocks in nature and is phenomenologically identical to the densification processes that take place within ceramic powder compacts during sintering at temperatures typically higher than 1200° C.

While the use of nanoparticles to accelerate the densification process of ceramic materials has been utilized for several decades and have recently also been exploited for sintering at milder temperatures, no evidence has been shown thus far that this effect can also be harnessed to densify carbonates into strong compacts at ambient temperature.

WO2017/058727A1, having a later filing and publication date than the first filing date of the present invention, but an earlier priority date, discloses cold sintering of micron-sized particles wetted by aqueous solutions at temperatures ranging from 100 to 200° C. The disclosure however is silent on the contribution of particle size to the observed phenomena.

Based on the above outlined state of the art, the objective of the present invention is to provide means and methods to allow low temperature formation of ceramic materials. This objective is attained by the subject matter of the independent claims.

As an example, the invention allows densifying of carbonate compacts at drastically accelerated time scales by decreasing the size of constituent particles to the nanoscale and utilizing higher pressures during the compaction process. Surprisingly, carbonate materials densified at ambient temperature within timescales of less than an hour can be even stronger than existing building materials. This technology is of particular advantage in working towards carbon-neutrality since it utilizes a potential CO₂-capturing chemical resource to replace key construction materials of currently large carbon footprints.

A first aspect of the invention relates to an industrial process for making a ceramic body. This process comprises the steps of
a. providing a precursor composition comprising particles of a precursor material, essentially a metal salt, wherein the particles have a diameter of less then 1 μm, and wherein the particles are wetted by a liquid medium in which said precursor material is at least scarcely soluble, and
b. applying a pressure of ≥100 MPa, particularly ≥200 MPa, ≥300 MPa, ≥400 MPa, or even ≥500 MPa to said precursor composition at a temperature below 200° C.

In certain embodiments, the pressure applied is in the range of 100 MPa to 200 MPa. In certain embodiments, the pressure applied is in the range of 100 MPa to 300 MPa. In certain embodiments, the pressure applied is in the range of 100 MPa to 400 MPa. In certain embodiments, the pressure applied is in the range of 100 MPa to 500 MPa.

In certain embodiments, the pressure applied is in the range of 200 MPa to 300 MPa. In certain embodiments, the pressure applied is in the range of 200 MPa to 400 MPa. In certain embodiments, the pressure applied is in the range of 200 MPa to 500 MPa.

In certain embodiments combining any particular one of the salts, pressure parameters and application times disclosed herein, the pressure is applied at a temperature of below 150° C., particularly at a temperature below 100° C., even more particularly below 60° C. or even at room temperature (approx. 25° C.).

The inventors have found that the requirement of a small particle size becomes ever more important at lower temperatures, and that while some materials may allow significant densification at higher temperatures even for coarsely grained material in the range of 500 to 600 nm, sintering at temperatures significantly below 100° C., particularly at below 60° C., more particularly below 50° C. and even more particularly at 35° C., 30° C. or at room temperature, require the presence of nanoparticles of below 150 nm average particle size.

One distinguishing feature of the process of the present invention is that the temperature of the precursor composition before applying the pressure can be well below the boiling point of the wetting liquid medium. In contrast to other low-temperature processes, the present one could be designated a non-hydrothermal process. Without wishing to be bound by theory, the inventors propose that for such room temperature processes [or near-room-temperature processes below 60°] all, or at least a significant portion of the particles of the precursor material must be nanoparticular, i.e. at or below 150 nm, particularly at or below 100 nm.

The inventors have found that for embodiments that make use of calcium or magnesium carbonate, the temperature of the process can be at or below room temperature. The same is true for the monetite isoform of calcium phosphate. Similarly, aluminium oxide of the Boehmite isoform has been successfully sintered at room temperature.

Other precursors, namely calcium phosphate precursors such as hydroxyapatite, may benefit from elevated temperatures, which however in any case never pass 200° C. and thus remain significantly lower than temperatures of known hot sintering processes.

In certain embodiments combining any particular one of the salts, pressure parameters and application times revealed herein, the pressure is applied at a temperature from 0° C. to 150° C. In certain embodiments combining any particular one of the salts, pressure parameters and application times revealed herein, the pressure is applied at a temperature from 0° C. to 100° C. In certain embodiments combining any particular one of the salts, pressure parameters and application times revealed herein, the pressure is applied at a temperature from 0° C. to 60° C.

The particles are essentially present in a shaped form, but the precursor composition comprises a liquid medium, typically at a liquid-to-solid ratio of 0.01 to 0.5, particularly 0.05 to 0.5, more particularly 0.1 to 0.4 or 0.2 to 0.4, even more particularly approx. 0.3 (all ratios given in mass per mass values).

The pressure is applied for longer than 300 s, particularly longer than 10 min or even 30 min. In most examples shown herein, the pressure was maintained for 30 min or 10 min. The highest densification speed is achieved during the first 5 minutes of applying the pressure, so where non-optimal densification results are acceptable in order to save process time, 5 minutes can suffice.

In certain embodiments, the precursor material is selected from the group comprised of salts of a group 1, 2, 3, 4, 5, 6, 7, 8, 9, 10, 11, 12, 13, 14 or 15 metal.

In certain embodiments, the precursor material is selected from the group comprised of salts of magnesium, calcium, strontium, barium, titanium, zirconium or aluminium.

In certain embodiments, the precursor material is a salt consisting of a group 1, 2, 3, 4, 5, 6, 7, 8, 9, 10, 11, 12, 13, 14 or 15 metal cation and an anion that is the base of a mineral acid, particularly a carbonate, a phosphate, a silicate, a hydroxide or an oxide. In cases where a sulfate, chloride, or fluoride or any other salt are characterized by a solubility that lends the material to the practice of the invention (i.e. ≥10E−5 mol/L solubility in a liquid medium), such sulfates (such as calcium sulfate), chlorides or fluorides, or other salts, may also be particularly useful embodiments of the invention.

In certain embodiments, the precursor material is calcium carbonate, magnesium carbonate, calcium phosphate, magnesium phosphate, calcium sulfate, barium titanate (BaTiO₃), zirconium oxide, yttrium oxide or zinc oxide of technical purity (≥90%).

In certain embodiments, the precursor material is a calcium carbonate, magnesium carbonate, calcium phosphate or magnesium phosphate of high (≥95%) purity or analytical grade purity ≥99%, or even higher purity (≥99.5 or ≥99.9%).

The inventors have demonstrated that pure CaCO₃ and pure MgCO₃ works well as a precursor material. They have also succeeded to cold sinter pure calcium phosphate as a precursor material, with a molar Ca/P ratio ranging from 0.8 to 1.8, particularly of a molar Ca/P ratio of 1.2.

The inventors believe that any salt characterized by a minimal solubility in a liquid medium amenable to wet the starting material is useful for practicing the invention. The starting material according to the broadest interpretation of the teaching provided herein is characterized by iono-covalent bonds, which excludes metals (i.e. oxidation state zero) and organic polymers. The method of the invention is characterized by compression of the starting material to a theoretical density above 64%, particularly above 67%, more particularly ≥70%, 73%, 78% or ≥80% of a theoretical maximal density determined for the precursor material.

In certain embodiments, the particles are characterized by a grain size of below 600 nm, particularly below 100 nm, or even more particularly at 50 nm or less. According to the results achieved by the inventors, the grain size does not have to be uniform, but more uniform grain sizes may be advantageous for the mechanical properties of the final product, particularly at smaller grain sizes. The grain size must be limited to below 1 μm to achieve high performance mechanical properties in the end product, and smaller grain sizes give better results.

In certain embodiments, the particles are characterized by a grain size of below 100 nm, particularly below 50 nm, and are present in agglomerates having a (secondary) grain size of below 1 μm.

Particularly impressive results can be achieved with hydroxyapatite crystal particles of below 30 nm diameter.

For any of the aspects and embodiments of the invention disclosed herein, the precursor material particles need to be wetted by a liquid medium, in which the precursor material is soluble to a sufficient degree that some minor fraction of the precursor material can transfer into the liquid phase, which is a process element that the inventors believe to be crucial—without wishing to be bound by theory—for the mechanism underlying the present invention. On the other hand, the solubility of the material must not exceed the threshold to transfer significant amounts of the precursor into the liquid phase.

In certain embodiments, the precursor material has a solubility of at least 10⁻⁵ mol/L. In certain embodiments, the precursor material has a solubility ranging from 10⁻⁵ mol/L to 10⁻² mol/L in the liquid medium. In certain embodiments, the precursor material has a solubility ranging from 5×10⁻⁵ mol/L to 5×10⁻³ mol/L in the liquid medium. In certain embodiments, the precursor material has a solubility ranging from 10⁻⁴ mol/L to 10⁻³ mol/L in the liquid medium. Each solubility value given in this paragraph refers to solubility at ambient pressure (approx. 100 kPa) and temperature (25° C.).

Literature values for calcium carbonate solubility are approx. 10⁻⁴ mol/L in water, with solubility increasing by up to two orders of magnitude with increasing pressure.

In certain embodiments, the precursor material particles are suspended in water. In certain embodiments, the precursor material particles are suspended in a solvent that comprises water and a water-miscible co-solvent. Non-limiting examples of water-miscible co-solvents for practicing the invention include ethylene glycol, methanol, ethanol, (iso- or n-) propanol, aqueous mineral acid (by way of non-limiting example: H₂SO₄, HCl, HNO₃, H₃PO₄, HF, HBr, H₂SO₃) organic acid (by way of non-limiting example: acetic acid, formic acid, lactic acid) and inorganic or organic base, hydrochloric acid and aqueous chelant solutions (by way of non-limiting example, chelants include ethylenediaminetetraacetic acid (EDTA), (2-hydroxyethyl)ethylenediaminetriacetic acid (HEDTA), ethylenediamine-N,N′-bis(2-hydroxyphenylacetic acid) (EDDHA), hydroxybenzyl ethylenediamine (HBED) and catecholate), catechol- and pyrogallol-based ligands. Chelants are employed advantageously particularly when the precursor compound is an oxide or hydroxide.

In certain embodiments, the process of the invention makes use of a precursor material that is obtained by dissolving a first metal salt in a first solvent. The first metal salt is constituted of a first anion and a first metal cation, yielding a first solution, and the first metal salt is soluble at significant concentrations (>0.1 mol/L) in the first solvent. Subsequently, the first solution is mixed with carbon dioxide by conducting a stream of the gas through the solution, or adding solid carbon dioxide into the solution, until the reaction is complete. In this case, the first solvent is selected to make sure that the resultant first metal carbonate is not soluble in the solvent, but will precipitate.

The inventors have found that working the process in a non-aqueous solution does not facilitate the densification and hardening characteristic of the present invention. The inventors have thus determined that water is an absolute requirement for the process. They tried several other solvents (ethanol, dodecane, acetonitril, propyl carbonate) and could not reproduce the densification behaviour observed when using water. Water/ethanol mixture on the other hand deliver the expected result, from which the inventors draw the conclusion that water is absolutely necessary but the amount can vary.

Alternatively, the first solution is mixed with a second solution of a second metal salt in a second solvent. In agreement with the terminology used in describing the first solution above, the second metal salt is constituted of a second anion and a second metal cation. In order to obtain a precipitate of the mixed salt of the second anion and the first metal cation, which the mixing of the two solutions will yield, the salt of first metal cation and second anion must not be completely soluble in the mix of said first and second solvent that results from the mixing. In certain embodiments, the first and second solvents are the same.

In certain embodiments, the precursor material is calcium carbonate and particles of the precursor material are obtained by mixing sodium carbonate and calcium chloride in an aqueous solution of ethylene glycol. The ethylene glycol is used as a co-solvent to decrease the particle size, which in absence of the co-solvent tends to result in CaCO₃ particles having a diameter of >1 μm. According to observation by the inventors, the particles size is more important than the solvent in the case of CaCO₃ precipitation. Other available methods to obtain <1 μm articles are similarly useful for the process. Optionally, the resultant slurry of particles is subsequently washed with ethanol and water to remove the ethylene glycol. This step is not required, the powder can be used as is for the densification to work. The step of cleaning and drying helps to have a more controlled starting material for the purpose of obtaining particularly high performance material.

In certain embodiments, cold isostatic pressure is applied. This form of pressure application is easily provided industrially or in the laboratory.

In certain embodiments, such as for example in the case of CaCO₃ densification, unidirectional pressing is preferred as it aids in removing fluid, which might be more difficult to achieve with isostatic pressing. For calcium phosphate densification however, the underlying mechanism of which the inventors hypothesize—without wishing to be bound by theory—to be plastic deformation, isostatic pressing can be used alternatively, resulting in a somewhat lower relative density, 75% compared to 85% as obtained by unidirectional properties, having similar mechanical properties, i.e. a strength of 17 MPa compared to 20 MPa for the material obtained by unidirectional pressing.

In a particular embodiment, the process of the invention comprises the steps of
a. providing a carbonate precursor composition consisting of particles of a precursor material wetted by a liquid medium, wherein
   i. the precursor material is a metal carbonate;
   ii. the particles are characterized by a grain size of below 1 μm, particularly below 600 nm, even more particularly below 100 nm, or even at 50 nm or less, and
   iii. the precursor material has a solubility in the liquid medium of ≥10⁻⁵ mol/L;
b. applying
   i. a pressure of ≥100 MPa, particularly ≥150 MPa, ≥200 MPa, ≥300 MPa, ≥400 MPa, or even more particularly ≥500 MPa,
   ii. at a temperature of ≤ (below or equal to) 200° C., particularly at a temperature below 100° C., even more particularly below 60° C. or even at room temperature (approx. 25° C.)
      to said precursor composition, resulting in a carbonate ceramic product.

In certain embodiments, this process for making a carbonate ceramic product involves application of pressure for longer than (≥) 5 min, particularly ≥10 min or 30 min.

In certain embodiments, the carbonate ceramic product resulting from this process is characterized by a density of greater or equal to 64%, particularly 67%, even more particularly ≥70%, 73%, 78% or ≥80% of a theoretical maximal density determined for the carbonate precursor material.

In certain embodiments, this process for making a carbonate ceramic product, the carbonate precursor material is a carbonate of a group 1, 2, 3, 4, 5, 6, 7, 8, 9, 10, 11, 12, 13, 14 or 15 metal.

In certain embodiments, this process for making a carbonate ceramic product, the carbonate precursor material is a carbonate of any one of magnesium, calcium, strontium, barium, titanium, zirconium or aluminium.

A second aspect of the invention relates to a ceramic body obtainable by the method according to the invention as characterized above.

In certain embodiments, this aspect relates to an industrially produced ceramic material characterized by the following parameters:
a. the material essentially consists of calcium carbonate of the vaterite isomorph;
b. the density of the material exceeds 1.76 g/cm³ and
c. the Modulus of rupture (MOR) for a X=11 mm by Y=2.2 mm by Z=1.8 mm sized specimen of said material loaded in a three point flexural test set up in the Y-axis exceeds 30 MPa.

In certain embodiments, the ceramic body is essentially constituted of CaCO₃ of the vaterite polymorph form having a density of ≥1.76 g/cm3 (70%). Vaterite is metastable at room temperature and will change into calcite or aragonite at around 200° C. The theoretical (maximal) density of vaterite is 2.51 g/cm³. To the best knowledge of the inventors, no dense (>1.76 g/cm3) bulk vaterite material has ever been obtained previously. CaCO₃ will decompose before becoming dense (at around 800° C.).

In certain embodiments, this aspect relates to an industrially produced ceramic material characterized by the following parameters:
a. the material essentially consists of calcium phosphate of monetite isomorph;
b. the density of the material exceeds 2.5 g/cm³ and
c. the Modulus of rupture for a 18 mm diameter, 2 mm thick disk specimen of said material loaded in the Y-axis, tested in a biaxial flexion set-up, exceeds 18 MPa.

The first important feature of the process of the present invention is the small particle size and composition (submicrometric preferably) of the precursor material particles. The larger the particle size, the lower the resulting mechanical properties will be for the sample. The inventors have found that use of 10 μm particles (instead of 0.6 μm) resulting in mechanical properties of little interest (the materials crumble when manipulated).

The second important feature is the liquid used for wetting the material. Water is normally used, in certain embodiments the water comprises additional organic or inorganic components to tune the solubility of the precursor material to the desired value. Non-limiting examples are ethylene glycol, methanol or ethanol. So other aqueous liquid media could be used, as long as the precursor material, particularly in the case of a carbonate, is slightly soluble in the liquid medium. The inventors have found that oil (silicon oil, paraffin oil etc.) in which the precursor material is completely insoluble, blocked the process.

The high pressure is a last important feature. Decreasing the applied pressure from 500 MPa (resulting in the best sample properties) to 100 MPa decreases the mechanical properties of the sample by a factor 5 also. The sample pressed at 100 MPa still had better properties than any other ceramic material made at room temperature (cement, gypsum, concrete). Decreasing the pressure even further is expected to decrease the mechanical properties to ranges where the invention is of little advantage.

Other secondary parameters that could influence positively or negatively the results based on the inventors' current understanding are the purity of the powder (the examples only use pure material), the temperature and the quantity of liquid.

One particular aspect that differentiates the current invention from state-of-the-art processes is that the whole process is performed at room temperature or slightly elevated temperatures, but <100° C. Any state of the art processes known to the inventors in which powder densification of ceramic materials were obtained at temperature lower than usual by applying pressure were still performed above 200° C. Additionally, none of those powders can be used as a carbon dioxide sink.

Among the competitive advantages of the present invention are: faster and less energy demanding ceramic material, the ability to shape ceramic material at room temperature and in one step; the replacement of a very carbon dioxide intensive material (cement) by a carbon neutral one (which might even remove net carbon from the atmosphere).

The term phosphate in the context of the present specification relates to metal salts of phosphoric acids. Hydrogen phosphates and dihydrogen phosphates are phosphates within the meaning of the term. Certain embodiments encompass phosphofluorides (e.g. hydroxyapatite) as well as other mixed phosphates.

Wherever alternatives for single separable features are laid out herein as “embodiments”, it is to be understood that such alternatives may be combined freely to form discrete embodiments of the invention disclosed herein.

The invention is further specified in a non-limiting way by the following items:

Item 1: A process for making a ceramic body, comprising the steps of
a. providing a precursor composition consisting of particles of a precursor material wetted by a liquid medium, wherein
   i. said precursor material is a metal salt;
   ii. said particles are characterized by a grain size of below 1 μm, particularly below 600 nm, even more particularly below 100 nm, or even at 50 nm or less, and
   iii. said precursor material has a solubility in said liquid medium of at least 10⁻⁵ mol/L;
b. applying
   i. a pressure of ≥100 MPa, particularly ≥150 MPa, ≥200 MPa, ≥300 MPa, ≥400 MPa, or even more particularly ≥500 MPa,
   ii. at a temperature of ≤(below or equal to) 100° C., particularly at a temperature below 80° C., even more particularly below 60° C. or even at room temperature (approx. 25° C.)
      to said precursor composition, resulting in a product ceramic body.

The process of item 1, wherein said pressure is applied for longer than 300 s, particularly longer than 10 min or even 30 min or more.

The process of item 1 or 2, wherein said product is characterized by a density of greater or equal to 64%, particularly ≥67%, even more particularly ≥70%, 73%, 78% or ≥80% of a theoretical maximal density determined for said precursor material.

The process of any one of the preceding items, wherein said precursor material is a salt of a group 1, 2, 3, 4, 5, 6, 7, 8, 9, 10, 11, 12, 13, 14 or 15 metal and a mineral acid, particularly a carbonate, phosphate, silicate, hydroxide, sulfate, oxide, chloride, fluoride, more particularly a carbonate or a phosphate of a group 1, 2, 3, 4, 5, 6, 7, 8, 9, 10, 11, 12, 13, 14 or 15 metal.

The process of any one of the preceding items, wherein said precursor material is selected from a salt of any one of magnesium, calcium, strontium, barium, titanium, zirconium or aluminium.

The process of any one of the preceding items, wherein said precursor material is selected from calcium carbonate, magnesium carbonate, calcium phosphate, magnesium phosphate, calcium sulfate, barium titanate, zirconium oxide, yttrium oxide and zinc oxide.

The process of any one of the preceding items, wherein said precursor material is calcium carbonate having a purity ≥90%, particularly ≥95%, more particularly ≥98%, ≥99% or ≥99%.

The process of any one of the preceding items, wherein said liquid medium is selected from water, an aqueous solution of methanol, ethanol, propanol, ethylene glycol, a mineral acid, an organic acid, an inorganic or organic base, and a chelant solution.

The process of any one of the preceding items, wherein said precursor material is obtained by
a. dissolving a first metal salt in a first solvent, wherein said first metal salt is constituted of a first anion and a first metal cation, yielding a first solution;
b. subsequently, mixing said first solution with
   iii. carbon dioxide, or
   iv. a second solution of a second metal salt in a second solvent, wherein said second metal salt is constituted of a second anion and a second metal cation, and a salt of said second anion and said first metal cation is not completely soluble in said first or second solvent or a mixture of said first and second solvent.

The process of any one of the preceding items, wherein said precursor material is calcium carbonate and said particles of precursor material are obtained by mixing aqueous solutions of sodium carbonate and calcium chloride.

The process of any one of the preceding items, wherein said precursor material is calcium carbonate and said particles of precursor material are obtained by streaming gaseous carbon dioxide through an aqueous calcium chloride solution.

The process of any one of the preceding items, wherein the pressure is applied uniaxially.

An industrially produced ceramic material characterized by the following parameters:
a. the material essentially consists of calcium carbonate of the vaterite isomorph;
b. the density of the material exceeds 1.76 g/cm³ and
c. the Modulus of rupture exceeds 30 MPa.

An industrially produced ceramic material characterized by the following parameters:
a. the material essentially consists of calcium phosphate of the monetite isomorph;
b. the density of the material exceeds 2.5 g/cm³ and
c. the Modulus of rupture exceeds 18 MPa.

The invention is further illustrated by the following examples and figures, from which further embodiments and advantages can be drawn. These examples are meant to illustrate the invention but not to limit its scope.

### BRIEF DESCRIPTION OF THE FIGURES

FIG. 1 shows the pressure solution creep mechanisms leading to cold sintering and vaterite nanoparticle synthesis and morphology. a, Schematics of the ionic transport mechanisms around the contact point between particles subjected to an external mechanical load, P. b, Formation of nanovaterite particles from the reaction of sodium carbonate with calcium chloride in an aqueous solution of ethylene glycol. Alternative sources of calcium and carbonate ions are also displayed. c, d, Scanning electron micrographs showing the hierarchical morphology of precipitated nanovaterite particles at different magnifications.

FIG. 2 shows results of the uniaxial compaction of nanovaterite powder in different continuous phases. a, Schematics of the compaction setup and the stress ramp applied during the experiments. σ is the externally applied stress, ΔL is the measured net dimensional change and t is the elapsed time. b, Dimensional change as a function of time for powder compacts in water, paraffin oil or in the dry state subjected to a maximum applied stress of 280 MPa. c, d, Densification behaviour and creep response of powder compacts in the presence of different continuous phases under an applied stress of 280 MPa.

FIG. 3 shows the densification behaviour of nanovaterite compacts and comparison with model geological calcite. a-c, Scanning electron micrographs of vaterite compacts subjected to different external stresses. d, Grain size distribution of compacts obtained at 10, 100 and 500 MPa. e,f, Densification behaviour and creep response of nanovaterite samples measured at different applied stresses. g, Logarithmic dependence of the relative density of vaterite compacts on the applied stress. h, Comparison between the creep response of nanovaterite and model geological calcite. i, Timescales required to increase the relative density of powder compacts by 0.4% as a function of the grain size and applied stress at room temperature.

FIG. 4 shows the mechanical properties of nanovaterite compacts and comparison to other classes of materials. a, Strength and elastic modulus of nanovaterite specimens as a function of the compact relative density. b, Ashby diagram displaying the specific modulus and specific compressive strength of the nanovaterite compacts in comparison to other man-made and natural materials. Data for the nanovaterite materials are indicated by red, orange and pink circles, which correspond to specimens with 87, 78, and 72% relative density, respectively.

FIG. 5 shows X-ray diffraction pattern of the powder synthesized according to Example 1. The powder is a mixture of vaterite and calcite. An average vaterite crystallite size of 37 nm was obtained by fitting the Scherrer equation to the three most intense Bragg peaks below 40°: (110), (112) and (114). The XRD patterns were recorded on an X'Pert Pro powder diffractometer (PANalytical B. V., Netherlands) operated in reflection mode with Cu K α radiation (45 kV, 40 mA).

FIG. 6 shows thermogravimetric and differential thermal analysis of the nanovaterite powder synthesised according to Example 1. The synthesised powder was slip cast to remove the excess of ethanol and dried at room temperature and pressure overnight. A 4 wt % weight loss above 100° C. can be observed and is probably due to residual solvent desorption. The second weight loss of 42 wt % is associated with the transformation from the carbonate CaCO₃ to the oxide CaO, releasing CO₂. The endothermic peak measured at this temperature supports the occurrence of this reaction. The exothermic peak around 400° C. is tentatively associated with the transformation of vaterite into calcite during heating1. The test was performed at a heating rate of 5° C./min from 35° C. to 900° C. under a 80:20 N₂:O₂ mixture with a TGA-DSC device (STA 449 C, Netzch).

FIG. 7 shows typical stress-strain curves obtained for cold sintered samples as provided in Example 1 under compression (a) and three-point bending (b). The average relative densities of the samples are written alongside the curves.

FIG. 8 shows the XRD spectrum of the material produced according to Example 2.

### EXAMPLES

### Example 1: Synthesis of Nanovaterite Particles

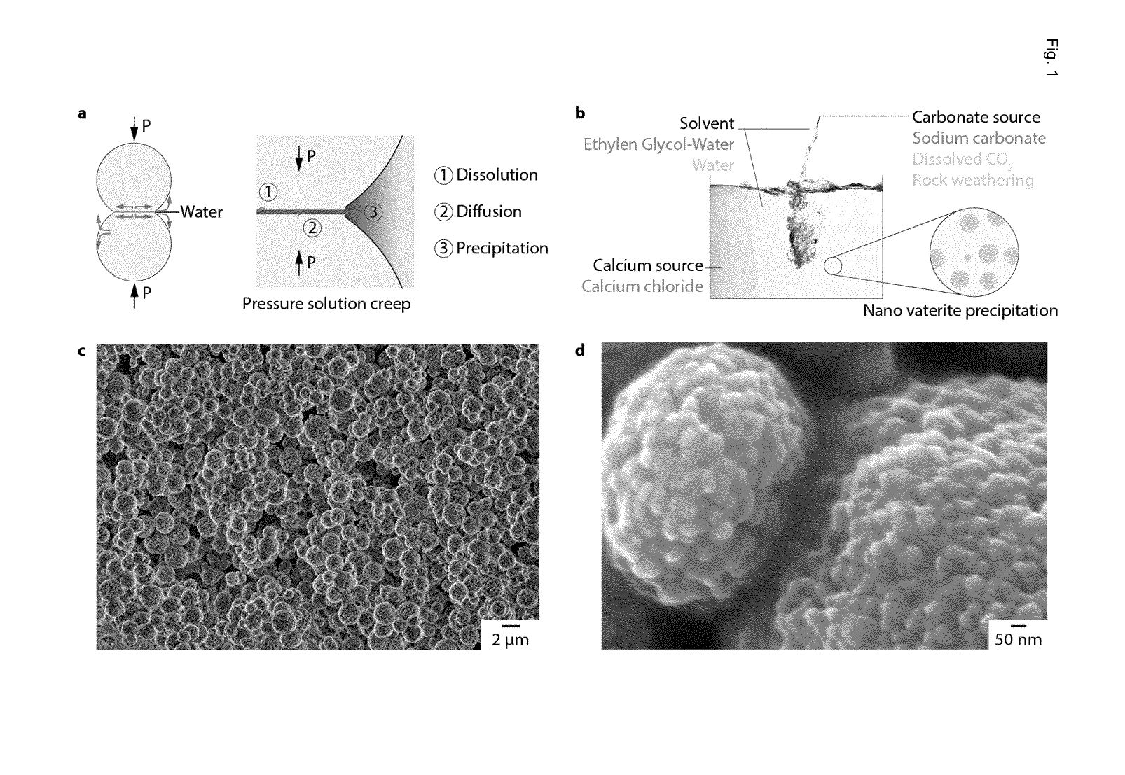

In this Example, sodium carbonate and calcium chloride are used as sources of CO₃²⁻ and Ca²⁺ ions, respectively. Vaterite nanoparticles are easily formed through simple mixing of these reactants in an aqueous solution of ethylene glycol (FIG. 1b). The resulting carbonate powder exhibits a unique hierarchical structure comprising 37 nm particles that are densely arranged into 0.6 μm spherical agglomerates (FIG. 1c, d, FIG. S1). After synthesis, the nanovaterite powder is washed with excess ethanol to remove the ethylene glycol before proceeding with compaction measurements.

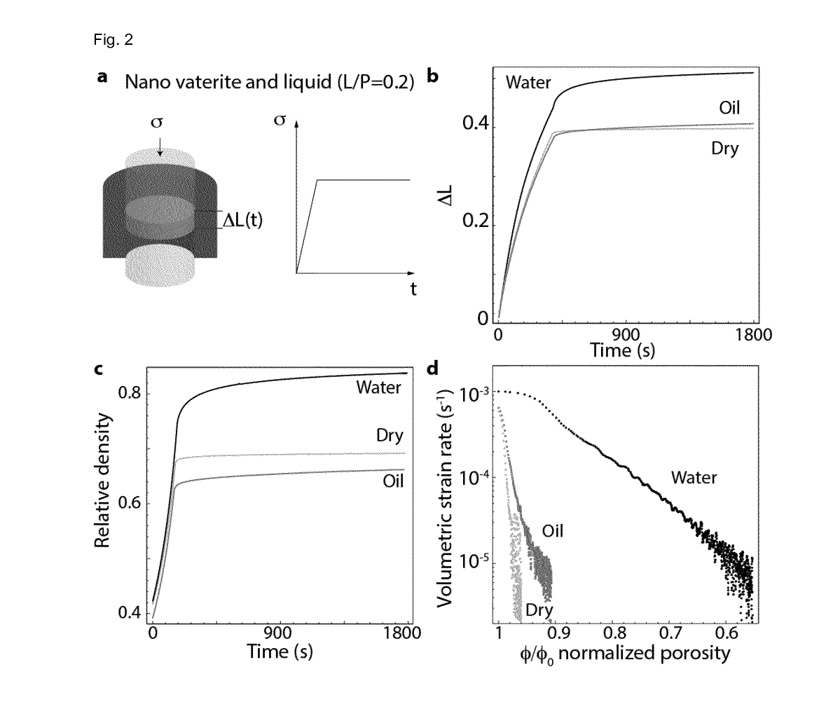

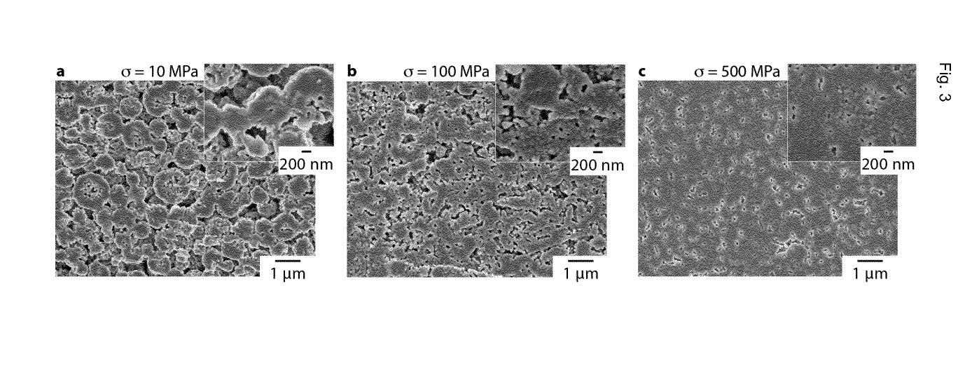

Compaction tests were performed by applying an uniaxial mechanical load onto a vaterite-liquid mixture added to a cylindrical mold at an initial solid-liquid weight ratio of 0.2 (FIG. 2a). The mechanical load applied to the mixture was first increased at a rate of 0.5 mm/min until the target maximum stress was reached. The dimensional change (ΔL) and respective uniaxial deformation (ε) along the loading axis were measured as a function of time while keeping the specimen under the constant target stress, σ.

Considering that an aqueous continuous phase is necessary to enable the dissolution of ions during pressure solution creep (FIG. 1a), the inventors first conducted experiments in the presence or absence of water to elucidate the role of cold sintering in the compaction process. For that purpose, vaterite powders mixed with water, paraffin oil or in the dry state were compacted uniaxially at the same target stress of 280 MPa. To quantify the level of densification achieved in the compaction process, the obtained raw deformation data (FIG. 2b) were converted into relative density values, leading to the densification curves shown in FIG. 2c. Compacts containing water reach a striking relative density of 84% at room temperature in a timeframe of only 30 minutes. By contrast, the presence of air or paraffin oil as continuous phase increases the relative density to only 68 and 64%, respectively. As ion dissolution should not occur in the oil or in air, this confirms that pressure solution creep is a key mechanism in the densification process of compacts in water. The deformation behavior of the investigated samples was also evaluated in terms of the strain rate as a function of normalized porosity (FIG. 2d). Although the finite increase in relative density in the absence of water (FIG. 2c) indicates that pure mechanical compaction also occurs in all the investigated specimens, the much higher strain rates achieved in water provides further evidence of the major role of pressure solution creep in enabling strong densification during compaction.

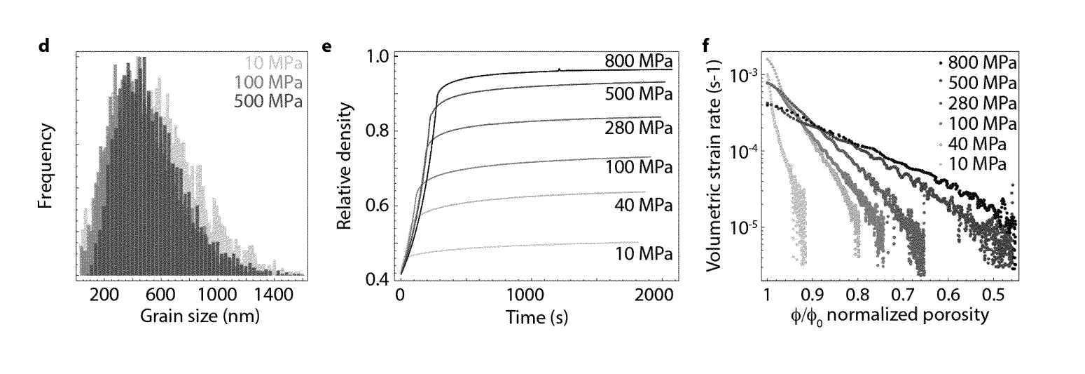

The evolution of the nano- and microstructure of the powder at different compaction stages was examined using scanning electron micrographs obtained from samples subjected to distinct applied stresses (FIG. 3a-c). At the low applied stress of 10 MPa, the spherical morphology of the nanovaterite agglomerates is still recognizable and the large inter-agglomerate interstices constitute a major fraction of the overall porosity. A higher applied stress of 100 MPa leads to significant densification and deformation of the agglomerates. This effect is further enhanced at 500 MPa, where agglomerates are no longer visible and only residual porosity remains. Interestingly, the densification processes achieved by increasing the applied pressure is not accompanied by the grain coarsening typically observed during sintering of ceramics at high temperatures (FIG. 3d). This is an important advantageous feature of the cold sintering process, since large grain sizes have a deleterious effect on the mechanical strength of brittle materials. Importantly, preliminary aging experiments in water revealed no phase transformation from vaterite to calcite within a timeperiod of two weeks after compaction, suggesting that the constrained environment within the dense compact prevents conversion of the carbonate into its thermodynamically stable phase.

The dependence of the relative density on the applied stress at room temperature was further evaluated by performing compaction tests over a wide range of pressures (FIG. 3e). A remarkable relative density of 87% is achieved at room temperature at a pressure of 500 MPa. Such a pressure level can be easily applied to compact parts at the tens of centimetre scale using a standard industrial hydraulic press. At the highest applied pressure of 800 MPa, the compact additional deformation is mostly elastic without significant further densification. The relative density of the powder compact was found to exhibit a logarithmic dependence on the applied stress (FIG. 3g), which qualitatively agrees with the behaviour expected for geological and synthetic materials. When the deformation response during the constant loading step is displayed in the form of creep curves (FIG. 3f), we observe that the strain rate of the compacts decreases from an initial value around 10⁻³ s⁻¹ to a level in the order of 10⁻⁵ s⁻¹ as densification proceeds. At any given relative porosity, higher strain rates are observed in compacts subjected to higher stresses, which explains the stronger densification of samples at elevated pressures.

A comparison of the creep data determined here with values reported in the literature at a low applied stress of 10 MPa reveals that the nanovaterite compact (grain size of 0.6 μm) deforms at strain rates many orders of magnitude higher than those obtained for a coarser natural calcite sample (grain size of 94 μm, FIG. 3h) (Croizéet al., J. Geophys. Res. 115, B11204 (2010)). Since other important parameters like diffusion coefficient or solubility are the same or only change slightly among CaCO₃ polymorphs, this difference must arise from the more than 100 times smaller sizes of the vaterite particles. Strain rates comparable to those measured for the nanovaterite at 10 MPa can only be achieved with geological model calcite by increasing the compaction temperature and pressure to 150° C. and 30 MPa, respectively, and by reducing the grain size to 12 μm (Zhang et al., J. Geophys. Res. 115, B09217 (2010)).

The densification of nanovaterite compacts occurs within remarkably shorter timescales if compared to model geological specimens with larger grain sizes. Experimental timescales obtained for the vaterite specimens produced according to the invention and literature values for calcite samples are shown in FIG. 3i for a wide range of grain sizes and applied stresses. The reported values correspond to the time needed to densify the compact by an arbitrary value of 0.4% at a constant applied stress and are thus indicative measures for the very early stage of the cold sintering process. Strikingly, reducing the grain size and increasing the applied stresses decreases the densification timescales from about 10 days to only a few seconds.

The compaction stresses and particle sizes covered herein exploit a completely new parameter space compared to earlier investigations on geological model systems (FIG. 3i). This opens the opportunity to produce CO₂-based powder compacts of relative densities comparable to those of state-of-the-art building materials within economically viable timescales and utilizing raw materials that can be used as CO₂ sinks. A major additional benefit of the proposed method is that it proceeds at room temperature, which contrasts to the energy-intensive heat treatments beyond 1000° C. typically employed in the cement and steel-making industries.

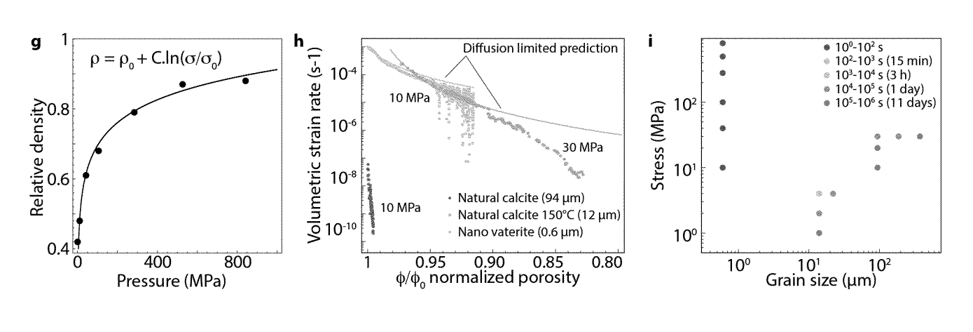

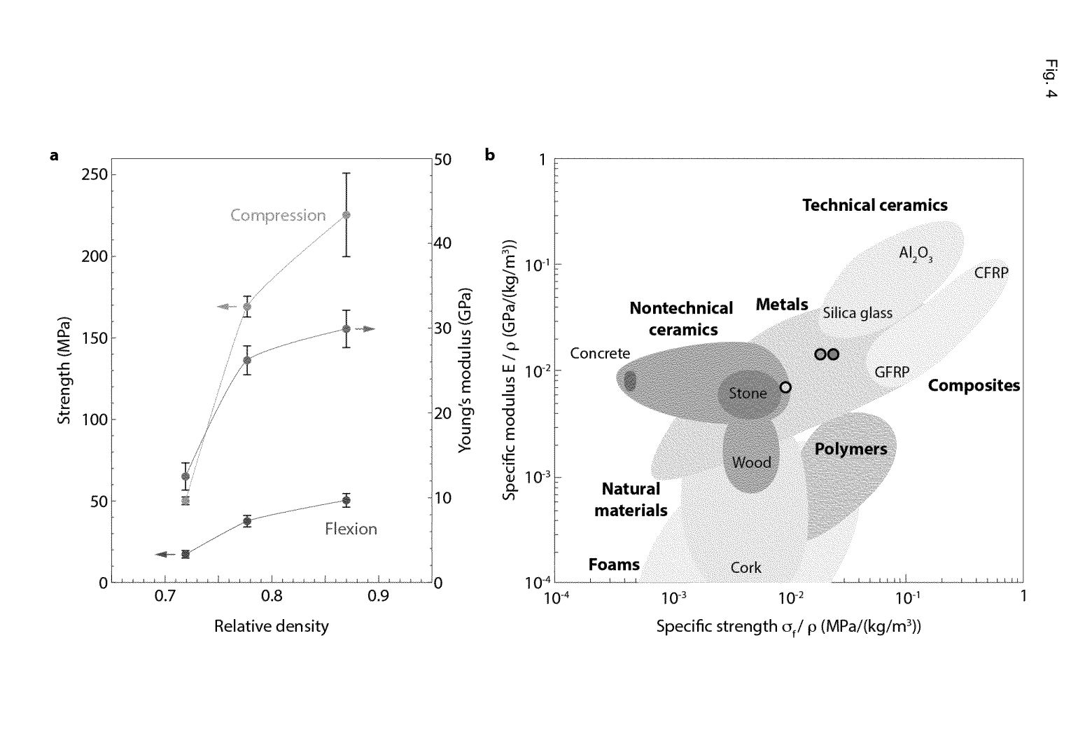

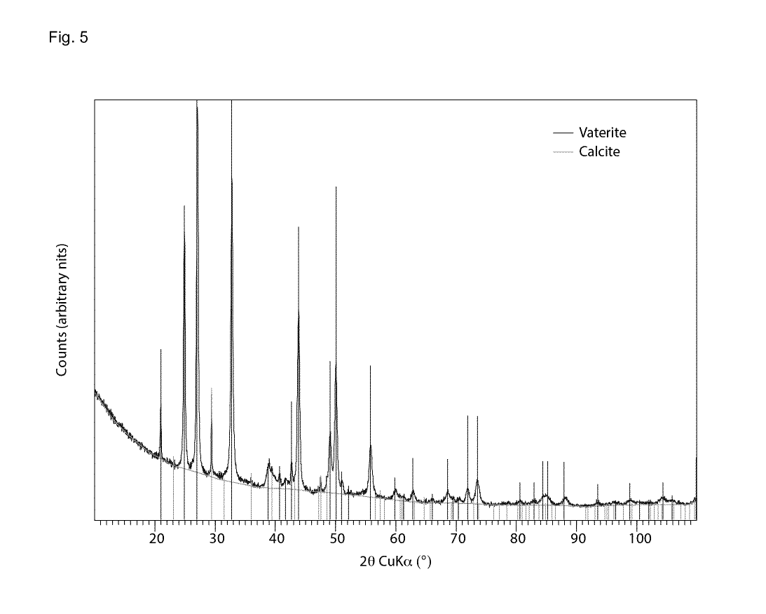

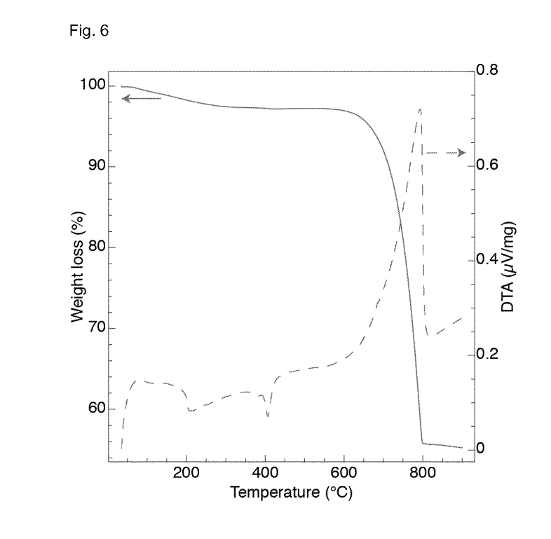

The high relative densities achieved through high-pressure cold sintering of nanopowders translate into surprisingly high mechanical properties for compacts fabricated at room temperature without the addition of binders (FIG. 4a). At a relative density of 87%, the cold sintered compacts exhibit an elastic modulus of 30 GPa combined with flexural and compressive strength of 50 and 225 MPa, respectively. If compared with other materials classes (FIG. 4b), the dense nanovaterite compacts outperform state-of-the-art construction materials like stone and concrete, reaching higher specific strength at comparable or even higher elastic moduli.

In conclusion, cold sintering of nanoscale carbonates at high pressures enables the fabrication of strong and dense structural materials at room temperature within timescales comparable to those of typical manufacturing processes. This simple up-scalable process can potentially revert today's negative environmental impact of the fast-growing construction sector, by providing a structural material that is sufficiently stiff and strong to replace current CO₂-emitting building resources and by utilizing carbonaceous raw materials that can work as CO₂ sinks at large industrial scales.

### Synthesis of Nanovaterite Particles

The inventors synthesized vaterite nanoparticles following a protocol originally proposed by Parakhonskiy et al. (Angew. Chem. Int. Ed. Engl. 51, 1195-7 (2012)). Briefly, two solutions comprising 20 vol % of distilled water and 80 vol % of ethylene glycol (>99%, Sigma Aldrich) were first prepared. CaCl₂.2H₂O (EMSURE® ACS, Reag. Ph Eur, Merck Millipore) was added to one solution, whereas NaCO₃.10H₂O (puriss. 99.5%, Sigma-Aldrich) was dissolved in the other. This resulted in water/ethylene glycol solutions containing 0.33 mol/L of either CaCl₂ or NaCO₃. A typical calcium chloride solution contained 8.00 g of water, 36.06 g of ethylene glycol, and 4.66 g of CaCl₂.2H₂O. For the sodium carbonate solution, 8.00 g of water, 36.06 g of ethylene glycol, and 9.06 g of NaCO₃.10H₂O were used. The two solutions were mixed quickly and kept under agitation at ˜600 rpm using a magnetic stirrer for 2 h. The precipitated powder was washed two times with ethanol (94% denaturated with Toluene, Alcosuisse) through sequential centrifugation steps and eventually stored in ethanol if not used. All chemicals were used as received without further purification.

Other methods can potentially be adapted to use carbon dioxide to produce carbonate powder. The differences compared to the route described in the preceding paragraph relate to the powder synthesis.

According to one alternative route, a solution of distilled water (20 vol %) and ethylene glycol (80 vol %; purity >99%, Sigma Aldrich) is first prepared. CaCl₂.2H₂O (EMSURE® ACS, Reag. Ph Eur, Merck Millipore) is added until a concentration of 0.33 mol/L (higher concentrations are possible and raising the concentration usually improves results). CO₂ is bubbled through the suspension while mixing at around 600 rpm until completion of the reaction.

Alternatively, two solutions comprising 20 vol % of distilled water and 80 vol % of ethylene glycol (>99%, Sigma Aldrich) are first prepared, and CaCl₂.2H₂O is added to one of them. Carbonation is then accelerated by amine-containing compounds, such as aqueous ethanediamine (EDA) and monoethanolamine (MEA), with characteristic absorption abilities toward acidic CO₂ gas. In one suspension, EDA and PEG (with 300 molar mass) are dissolved in equimolar quantity as the desired CO₂ and calcium source³. In one embodiment, both reagents are present at 0.33 mol/L. The two solutions are mixed quickly and keep under agitation at ˜600 rpm using a magnetic stirrer for 2 h.

For both alternatives of the powder synthesis method, the precipitated powder may optionally be subsequently washed two times with ethanol through sequential centrifugation steps and stored in ethanol, or used directly for compaction.

In a typical example of the present invention, the powder stored in ethanol was slip casted on a gypsum mould to remove the excess of solvent and dried at 100° C. 2 h (the drying step is optional). The desired amount of powder was weighted (typically 0.5 g) and loaded in a 13 mm diameter pressing tool. A 0.9 wt %. NaCl in distilled water solution was added at a weight ratio L/P=0.2, then the pressing tool was closed and loaded in an uniaxial press (200 kN capacity, P/O/Weber, Germany) at various load for at least 2 h. The samples were then removed and dried 2 h at room temperature. A typical sample size obtained were 13 mm diameter by 2.2 mm thick, but larger samples has also been obtained. The best samples were obtained for a pressure of 66 kN on a pressing tool of 13 mm diameter (corresponding to 500 MPa), but pressure and diameter were varied (pressure from 100 MPa to 500 MPa, diameter of the sample from 11 mm to 30 mm) successfully.

### Structural Characterization

Cross-sections of the sample were obtained using a Broad Ion Beam milling instrument (IM4000, Hitachi, Japan) available at ETH Zurich (ScopeM). Milling was performed using an argon gun accelerated under 6 kV while the sample was wobbled at a middle speed (C3) to avoid heating. Electron microscopy images were acquired after deposition of a 5 nm layer of platinum on the nanovaterite powder and on the polished compact surface (LEO1530, Zeiss, Germany).

### Creep Tests

The suspension of nanovaterite particles in ethanol was first slip cast in a gypsum mold to remove the excess of ethanol. The powder obtained was dried at 100° C. for 2 h. To perform the compaction experiments, 0.3 g of nanovaterite powder was added into the cavity of a pressing tool of 11 mm diameter (P/O/Weber, Germany). The desired amount of liquid was added directly on top of the powder. A liquid-to-powder (L/P) weight ratio of 0.2 was used. This ratio was typically obtained by mixing 0.060 g of liquid with 0.300 g of powder. The liquid used for most creep tests consisted of a 0.9 wt % aqueous solution of NaCl (EMSURE, Merck). This NaCl concentration is known to increase the CaCO₃ solubility. Paraffin oil (Sigma-Aldrich) was used in selected experiments to test the effect of the type of liquid on the compaction behavior. To investigate the creep response of the nanovaterite powder the pressing tool was closed and placed in a universal testing machine (Instron 8562, Instron) equipped with a 100 kN load cell. A preload of 200 N (corresponding to 2.1 MPa) was applied on the specimen to ensure a common starting point for the compaction tests. The compaction pressure was then applied at a rate of 0.5 mm/min until the maximum load was reached. This was followed by the application of a constant load that was maintained for time periods ranging from 30 minutes to 1 hour. For each load, a background displacement curve was obtained with an empty pressing tool. This displacement was then subtracted from the actual values measured with the powder to remove the contribution of the tools to the total deformation. To calculate the density of the compacted specimens, the powder masses were measured 24 h after pressing to take into account any loss that may have occurred during the compaction process. The thickness and diameter of the samples were deduced from the displacement of the machine and the diameter of the pressing tool, respectively. Archimedes measurements confirmed that the geometric density measured during the tests were correct within +/−5%.

### Grain Size Analysis

The grain size of the cold sintered samples was measured with the freely available software Fiji. Several SEM images were stitched together with a dedicated plug-in³ to obtain a larger number of grains while keeping a resolution high enough to distinguished the pores and grain boundaries. A simple threshold was used to separate the pores from particles, followed by a 2 pixels median filtering procedure to remove noise in the image. The plug-in Watershed was then used to join the pores together and thus retrace the grain boundaries. The resulting grain boundaries and the original image were overlaid to check the accuracy of the method. The plug-in “Analyse Particles” was finally used to obtain the grain size distribution.

### Strain Rate Modelling

The calculation of the theoretical strain rate of the vaterite samples during compaction was performed using the established pressure solution creep model outlined by Zhang et al. (J. Geophys. Res. 115, B09217 (2010)).

Mechanical testing

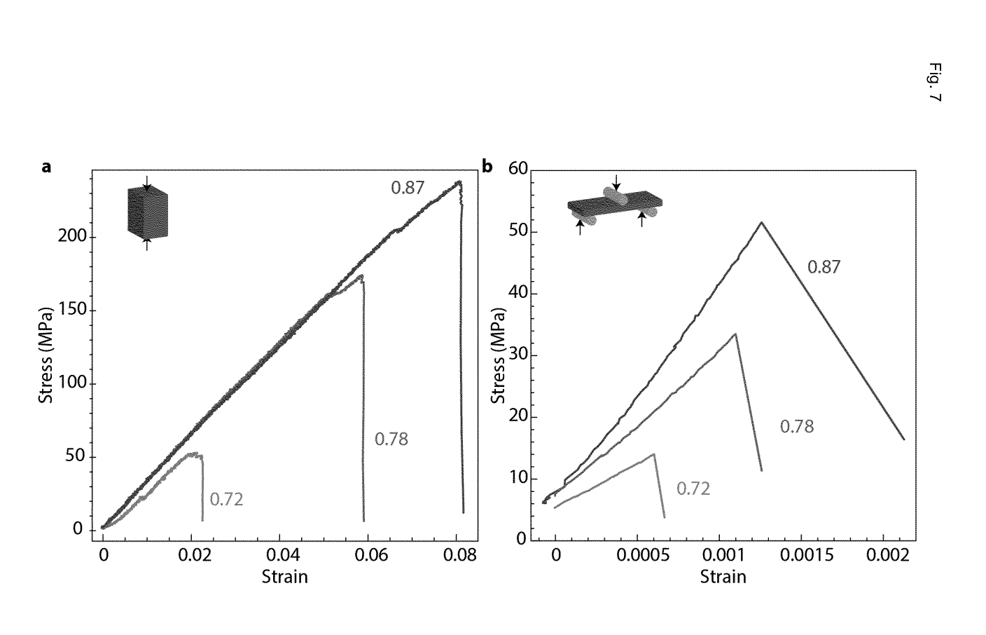

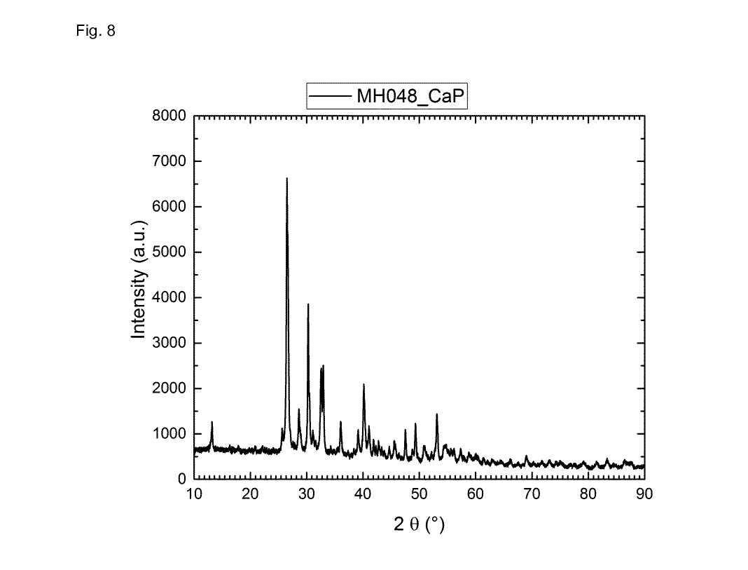

Samples for mechanical testing were prepared following the same overall protocol used for the creep tests but upscaled for a larger amount of powder (typically 0.5 g). In this case, compaction was carried out using a 13 mm diameter pressing tool in an uniaxial press (200 kN capacity, P/O/Weber, Germany) at various loads for at least 2 h. After pressing, samples were removed and dried for 2 h at room temperature. A typical sample showed a diameter of 13 mm and was 2.2 mm thick, but larger specimens were also obtained. Such disks were cut with a 300 μm wire saw to generate beams of approximately 11×2.2×1.8 mm³ (Length×Depth×Width) and cuboids of approximately 1.7×1.7×2 mm³ for the three point bending and compression tests, respectively. Samples for bending tests were bevelled at the edges and used directly after cutting. All the tests were performed with a Instron 8562 universal testing machine equipped with a 1 kN load cell. A three-point bending setup with a span of 9.4 mm and a constant loading speed of 1 μm.s⁻¹ was utilized. The beam deflection was measured using a linear variable differential transducer (LVDT) setup. Compression experiments were also performed at a constant displacement speed of 1 μm.s⁻¹. Representative curves for each test are plotted in FIG. 7. At least three specimens were tested for each composition. The reported values are averages and standard deviations thereof.

### Example 2: Calcium Phosphate Synthesis Route

The method used to synthesize the calcium hydrogen phosphate platelets was originally developed by Jha et al., AIMS Materials Science 1 (2014). The following steps characterize the protocol:
1. Two solutions containing the precursor salts in water at a concentration of 1 mol/l each are prepared:
   a. calcium nitrate tetrahydrate (Ca(NO₃)₂.4H₂O, Sigma-Aldrich) and
   b. ammonium phosphate dibasic ((NH₄)₂HPO₄, Sigma-Aldrich).
2. 120 ml deionized water was added to 120 ml Ca(NO₃)₂.4H₂O solution and 100 ml deionized water was added to 100 ml (NH₄)₂HPO₄ solution.
3. The (NH₄)₂HPO₄ solution was added drop by drop to the Ca(NO₃)₂.4H₂O solution under vigorous stirring (1000 rpm). The milky suspension was stirred for an hour.
4. The suspension was filtered (MD 615) and dried in an oven at 60° C. Depending on the time in the oven, two different crystal phases can result from this procedure (Hydrate phase: Brushite, or anhydrate phase: Monetite).
5. The dry powder was ground in a mortar and stored ready to use.
6. For a typical compression experiment, 1.22 g of powder was filled in the cavity of the mould (P/O/Weber, Germany). This was placed in a uniaxial press (200 kN capacity, P/O/Weber, Germany) and 160 KN of force was applied. Optionally additional liquid was added (up to a ratio powder to liquid of 0.3). The liquid used was a 0.9 wt % NaCl solution.

Typical results from a test with the anhydrate phase (Monetite) and no additional liquid:
Density: 2.534 g/cm³
Strength at break as described in the mechanical test of example 1:22 MPa (±1.5 MPa)

The modulus of rupture (MOR) was measured on a disk sample of at least 18 mm diameter and 2 mm thickness, with a setup called biaxial flexion, and the maximum value was 20 MPa.

### Example 3: Application of Cold Sintering to Different Materials

Calcium Carbonate (Vaterite)
Cold sintering achieved with any size of vaterite agglomerates which consist of small nanoparticles. Ethylene glycol may be employed to reduce the agglomerate size.
The agglomerate size does not have an influence on the process and final maximal density. However the mechanical properties are worse (around ½) with larger agglomerate sizes (which is probably related to the bigger pore size); nanoparticles are absolutely required as starting material.

Calcium Phosphate (Monetite):
Platelet-like particles consisting of nanoparticles (produced by the co-precipitation route and under dried at 100° C. for several days). Pressed with water (1 g powder and 0.3 ml water) at 500 MPa for 1 hour.
Product: Very dense material, insoluble in water

Calcium Phosphate (Hydroxyapatite)
Monetite platelets, which undergo phase transformation when left in 0.1M NaOH solution overnight. The platelet shape remains after the phase transformation. Pressed with water (1 g powder and 0.3 ml water) at 500 MPa for 1 hour.
Product: Imaging indicates very dense structure.

Magnesium Carbonate (Amorphous)
Nano particles produced by the co-precipitation method. After pouring the two solution in one beaker, the particles were washed immediately to prevent crystallization. Pressed without water (1 g powder and 0.3 ml water) at 500 MPa for 1 hour.
Product: Very dense structure.

Boehmite (Commercial Product)
Disperal P2W (Sasol, Germany). Pressed with water (0.2 g powder and 0.08 ml water) pressed at 500 MPa for 1 hour.
Product: Very dense structure.

1. A process for making a ceramic body, comprising the steps of
a. providing a precursor composition consisting of particles of a precursor material wetted by a liquid medium, wherein
i. said precursor material is a metal salt;
ii. said particles are characterized by a grain size of below 600 nm, even more particularly below 100 nm, or even at 50 nm or less, and
iii. said precursor material has a solubility in said liquid medium of at least 10⁻⁵ mol/L;
b. applying
i. a pressure of ≥100 MPa, particularly ≥150 MPa, ≥200 MPa, ≥300 MPa, ≥400 MPa, or even more particularly ≥500 MPa,
ii. at a temperature of ≤100° C., particularly at a temperature below 80° C., even more particularly below 60° C. or even at room temperature (approx. 25° C.)
to said precursor composition, resulting in a product ceramic body.

2. The process of claim 1, wherein said particles are characterized by a grain size of below 100 nm.

3. The process of claim 1, wherein said particles are characterized by a grain size of 50 nm or less.

4. The process of claim 1, wherein the pressure is applied at room temperature.

5. The process of claim 1, wherein said pressure is applied for longer than 300 s, particularly longer than 10 min or even 30 min or more.

6. The process of claim 1, wherein said product is
characterized by a density of greater or equal to 64%, particularly ≥67%, even more particularly ≥70%, 73%, 78% or ≥80% of a theoretical maximal density determined for said precursor material.

7. The process of claim 1, wherein said precursor material is a salt of a group 1, 2, 3, 4, 5, 6, 7, 8, 9, 10, 11, 12, 13, 14 or 15 metal and a mineral acid, particularly a carbonate, phosphate, silicate, hydroxide, sulfate, oxide, chloride, fluoride, more particularly a carbonate or a phosphate of a group 1, 2, 3, 4, 5, 6, 7, 8, 9, 10, 11, 12, 13, 14 or 15 metal.

8. The process of claim 1, wherein said precursor material is selected from a salt of any one of magnesium, calcium, strontium, barium, titanium, zirconium or aluminium.

9. The process of claim 1, wherein said precursor material is selected from calcium carbonate, magnesium carbonate, calcium phosphate, magnesium phosphate, calcium sulfate, barium titanate, zirconium oxide, yttrium oxide and zinc oxide.

10. The process of claim 1, wherein said precursor material is selected from
a. the vaterite isomorph of calcium carbonate,
b. the monetite isomorph of calcium phosphate,
c. the hydroxyapatite isomorph of calcium phosphate, and
d. the boehmite isomorph of aluminium oxide hydroxide.

11. The process of claim 1, wherein said precursor material is calcium carbonate having a purity ≥90%, particularly ≥95%, more particularly ≥98%, ≥99% or ≥99.9%.

12. The process of claim 1, wherein said liquid medium is
selected from
a. water,
b. an aqueous solution of a compound selected from the group consisting of methanol, ethanol, propanol, ethylene glycol, a mineral acid, an organic acid, an inorganic or organic base, and a chelant, particularly wherein the chelant is selected from EDTA, HEDTA, EDDHA, HBED and catecholate, catechol- and pyrogallol-based ligands.

13. The process of claim 1, wherein said precursor material is obtained by
a. dissolving a first metal salt in a first solvent, wherein said first metal salt is constituted of a first anion and a first metal cation, yielding a first solution;
b. subsequently, mixing said first solution with
i. carbon dioxide, or
ii. a second solution of a second metal salt in a second solvent, wherein said second metal salt is constituted of a second anion and a second metal cation, and a salt of said second anion and said first metal cation is not completely soluble in said first or second solvent or a mixture of said first and second solvent.

14. The process of claim 1, wherein said precursor material is calcium carbonate and said particles of precursor material are obtained by mixing aqueous solutions of sodium carbonate and calcium chloride.

15. The process of claim 1, wherein said precursor material is calcium carbonate and said particles of precursor material are obtained by streaming gaseous carbon dioxide through an aqueous calcium chloride solution.

16. The process of claim 1, wherein the pressure is applied
uniaxially.

17. An industrially produced ceramic material, particularly obtained by a process
according to claim 1, characterized by the following parameters:
a. the material essentially consists of calcium carbonate of the vaterite isomorph;
b. the density of the material exceeds 1.76 g/cm³ and
c. the Modulus of rupture exceeds 30 MPa.

18. An industrially produced ceramic material, particularly obtained by a process
according to claim 1, characterized by the following parameters:
a. the material essentially consists of calcium phosphate of the monetite isomorph;
b. the density of the material exceeds 2.5 g/cm³ and
c. the Modulus of rupture exceeds 18 MPa.
